(19) United States
(12) Patent Application Publication
(10) Pub. No.: US 2011/0259763 A1
(43) Pub. Date: Oct. 27, 2011

(54) Artist palette

(76) Inventor: Thomas O'Brien, Phoenixville, PA (US)

(21) Appl. No.: 12/807,478

(22) Filed: Sep. 7, 2010

Related U.S. Application Data
(60) Provisional application No. 61/343,162, filed on Apr. 23, 2010.

(51) Int. Cl. B44D 3/02

(52) U.S. Cl. 206/1.7

(57) ABSTRACT

An artist palette is disclosed comprising a three-point anchor system for improved comfort and ease of use. The system comprises a first anchor point including a thumb resting surface and a grasping surface, a second anchor point including a forearm resting surface forming a line with the first anchor point parallel to the forearm, and a third anchor point including a torso resting surface forming a triangle together with the first anchor point and the second anchor point. Optionally, the grasping surface rests inside the palette and either one or more of the forearm resting surface and the torso resting surface includes a concave arc curving toward the first anchor point.

### CLAIM OF PRIORITY

This application claims priority to U.S. provisional patent application Ser. No. 61/343,162, filed Apr. 23, 2010, which is incorporated herein by reference in its entirety.

### FIELD OF INVENTION

The invention relates to palettes used by artists in general and may be especially suitable for portrait, figure, still-life, mural and landscape painters.

### BACKGROUND

Throughout centuries, a great variety of shapes and designs have been provided for artist palettes in which an artist can hold a palette with one hand by placing a thumb through an opening in the bottom thereof and gripping the palette with the palm and the remaining digits. An illustration of the palettes well know in the art is shown in Figure A, corresponding to the classic palette design used by the foremost portraitist Gilbert Stuart (1755-1828), now maintained by the National Portrait Gallery, Smithsonian Institution.

It is widely recognized that painting is an exacting and labor intensive art form. The artist must often operate at considerable extended times with weight of the palette on an arm and sometimes a forearm.

However, because of the traditional shape and weight distribution, a conventional artist's palette design has not offered an ergonomic solution. That is, an artist would hold a palette for scores of hours, weeks and even months at a time, while risking straining muscles and tendons in the palette-holding wrist, hand and forearm. The conventional palette design simply did not allow for more than one anchor point to both hold the palette and also to distribute the strain associated with its weight and holding pattern.

More recently, some have suggested using a counterweight for balance, while using the forearm as the balance beam forming the second anchor and a pivot to balance the palette weight. For example, Pro Series 3 Palette manufactured by Turtlewood Palettes, www.turtlewoodpalettes.com, teaches “a counterweight for balance, lightweight and ergonomically correct hold”. Pro Series New Rectangular Palette also teaches it “is uniquely designed with the thumb grip in the middle to correct balance of the palette.” Similarly, Armed Palettes produced by Richeson Art Supplies, www.richesonart.com, shows “spacious old-world palette is designed for comfort and reduced fatigue. Even though it is larger and heavier than other palettes, its shape and balance (due to a counter-weight) help distribute the palette's weight over the whole arm instead of just at the wrist.” Mr. Juan Martinez, in his The Academy Way Figure Painting article teaches using the palette shape to more evenly distribute the weight helps “keep the palette evenly balanced on my arm so my hand and fingers do not tire from holding it.”

However, the more recent weight balancing solutions, while overcoming some challenges with the classic palette design to minor extent, do not offer a complete solution. More specifically, neither classic nor more recent two-anchor point designs teach or suggest an ergonomically designed artist palette using a third anchor point to address the problems. None of the prior designs teach to anchor the palette using a torso or hip resting surface optionally including a concave arc curving toward the thumb resting surface. Indeed, all prior art designs teach the opposite.

The terms anchor point, line, angle and triangle, as used herein and throughout this application, are defined to include the standard meaning as defined in classic geometry.

It is accordingly toward this end that the present invention is directed.

### SUMMARY

The subject invention teaches an artist palette comprising a first, second and third anchor points. The first anchor point includes a thumb resting surface and a grasping surface. The second anchor point includes a forearm resting surface forming a line with the first anchor point parallel to the forearm. The third anchor point includes a torso or a hip resting surface forming a triangle together with the first and the second anchor points. In one embodiment, the first anchor point is located internally to the area of the palette circumference. In yet another embodiment, the third anchor point further includes a hip resting surface. In yet another embodiment, the grasping surface rests inside the palette and either one or more of the forearm resting surface and the torso or a hip resting surface includes a concave arc curving toward the first anchor point.

The palette substrate may be made of a combination of wood, plastic, acrylic, paper or composite materials.

It is an object of the subject invention to provide an artist palette particularly adapted for painting, such as portrait or landscape painting, including by Western art painters, marine painters, seascape painters, still life painters, figure painters, mural painters, landscape painters, bird and animal painters, pet painters, floral painters, history painters, religious painters, and many other painting disciplines.

It is another object to provide a palette to improve the painting experience by reducing the stress on the hand, digits, wrist, palm, forearm and arm associated with holding and grasping an artist palette for sustained amount of time during painting.

The above and yet other objects and advantages of the present invention will become apparent from the hereinafter set forth Brief Description of the Drawings, Detailed Description of the Preferred Embodiments and Claims appended herewith.

### BRIEF DESCRIPTION OF THE DRAWINGS

FIG. A shows the prior art classic palette known as conventional artist palettes, corresponding to the classic palette design used by the foremost portraitist Gilbert Stuart (1755-1828), now maintained by the National Portrait Gallery, Smithsonian Institution.

FIGS. 1 and 2 illustrate the novel palette design, whereby the first anchor point is located internally to the area of the palette circumference.

FIGS. 3 and 4 illustrate the novel palette design, whereby the third anchor point further includes a torso or hip resting surface.

FIG. 5 illustrates the novel palette design, fitted to be used with a Jullian French sketch box.

FIGS. 6 and 7 illustrate additional embodiments of the new palette design.

FIG. 8 illustrates superimposed view of the new palette designs.

### DETAILED DESCRIPTION OF THE PREFERRED EMBODIMENTS

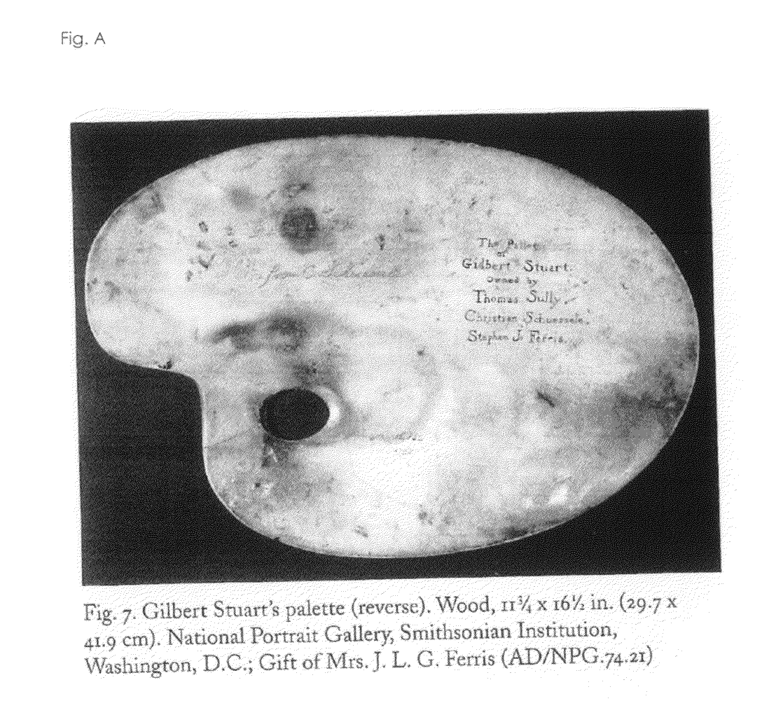

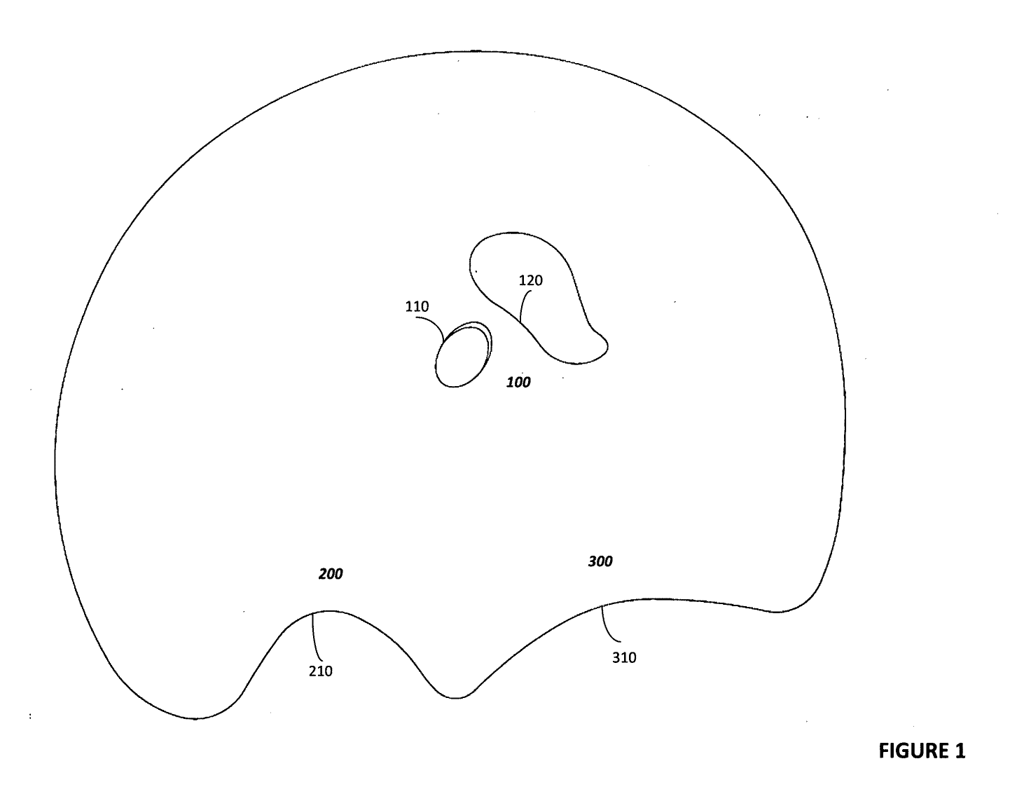

FIG. 1 illustrates an embodiment of the novel palette comprising a first anchor point 100 including a thumb resting surface 110 and a grasping surface 120. FIG. 1 also shows a second anchor point 200 including a forearm resting surface 210 forming a line with the first anchor point 100 parallel to the forearm; and a third anchor point 300 including a torso resting surface 310 forming a triangle together with the first anchor point 100 and the second anchor point 200. In one embodiment, the first anchor point 100 is located internally to the area of the palette circumference. However, it is to be understood that the present invention is not limited to any particular shape.

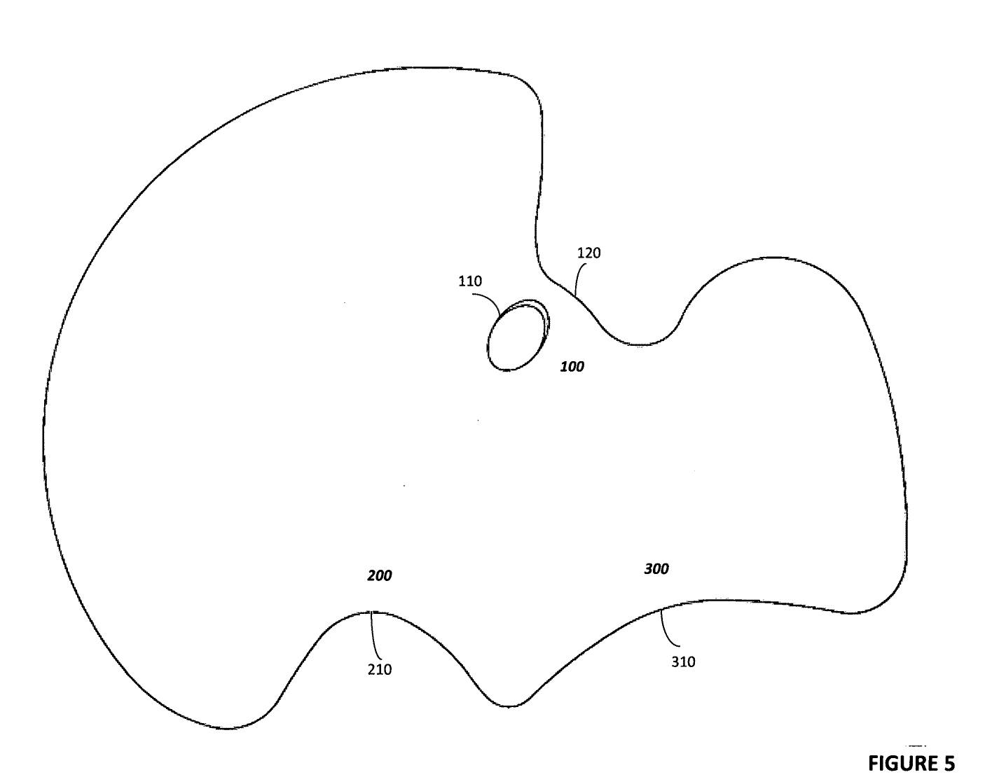

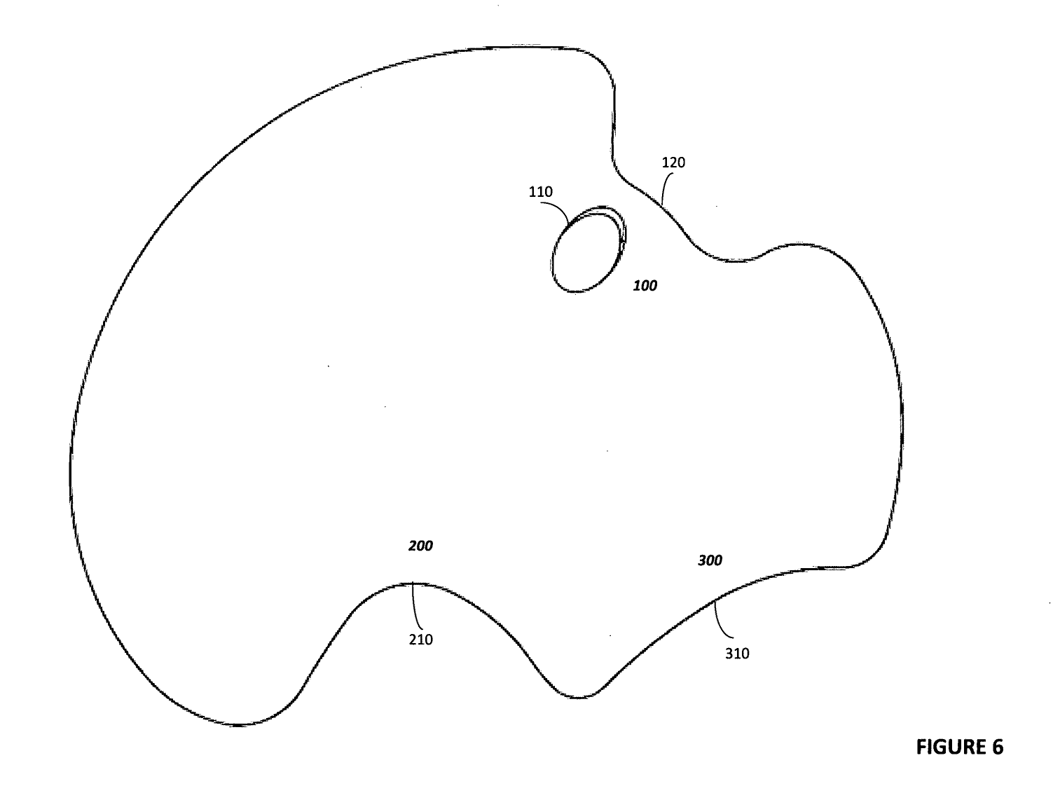

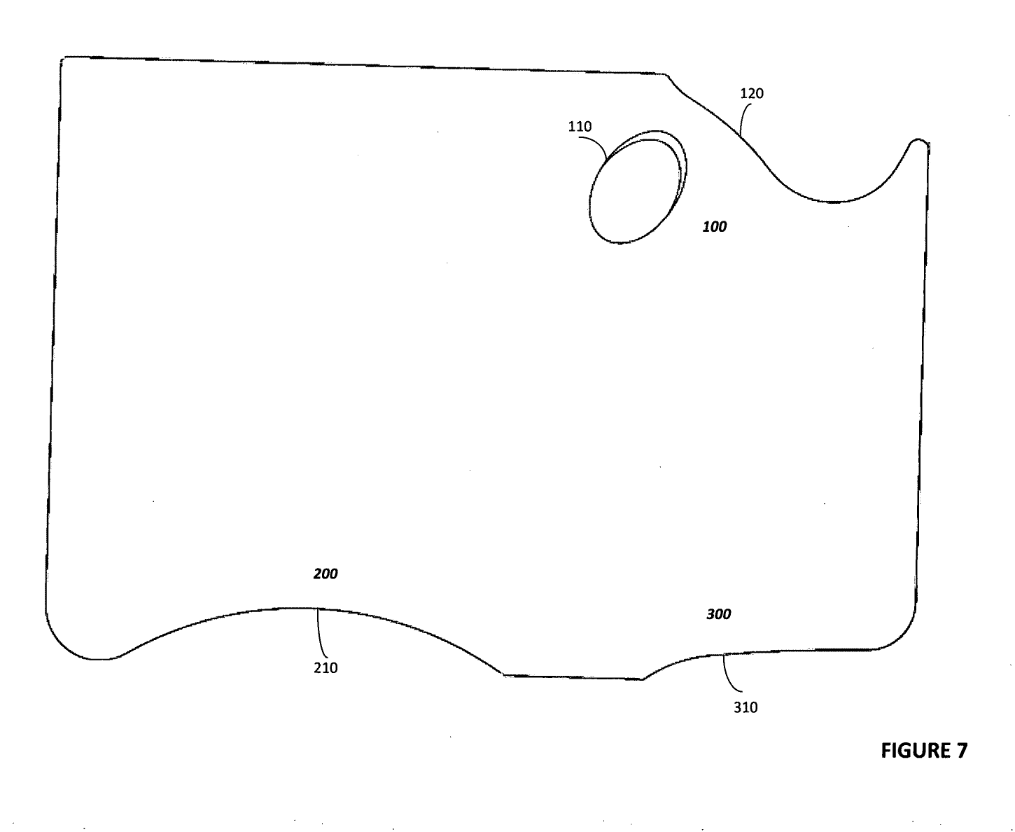

The thumb resting surface 110 in each of the embodiments shown in FIGS. 1 through 7 is provided to assist in holding the palette on the forearm. The classic shape of the thumb resting surface 110 is intended for carrying the palette while in use. In one embodiment, the thumb may be placed through an opening in the bottom thereof and resting the palette on the lower quadrant of the index finger with the remaining digits fanning away from the thumb so the artist can hold paint brushes, if so desired. In one embodiment of the invention, the same may be readily reversed to its mirror image for a left or a right handed person to carry the palette on the non-painting forearm.

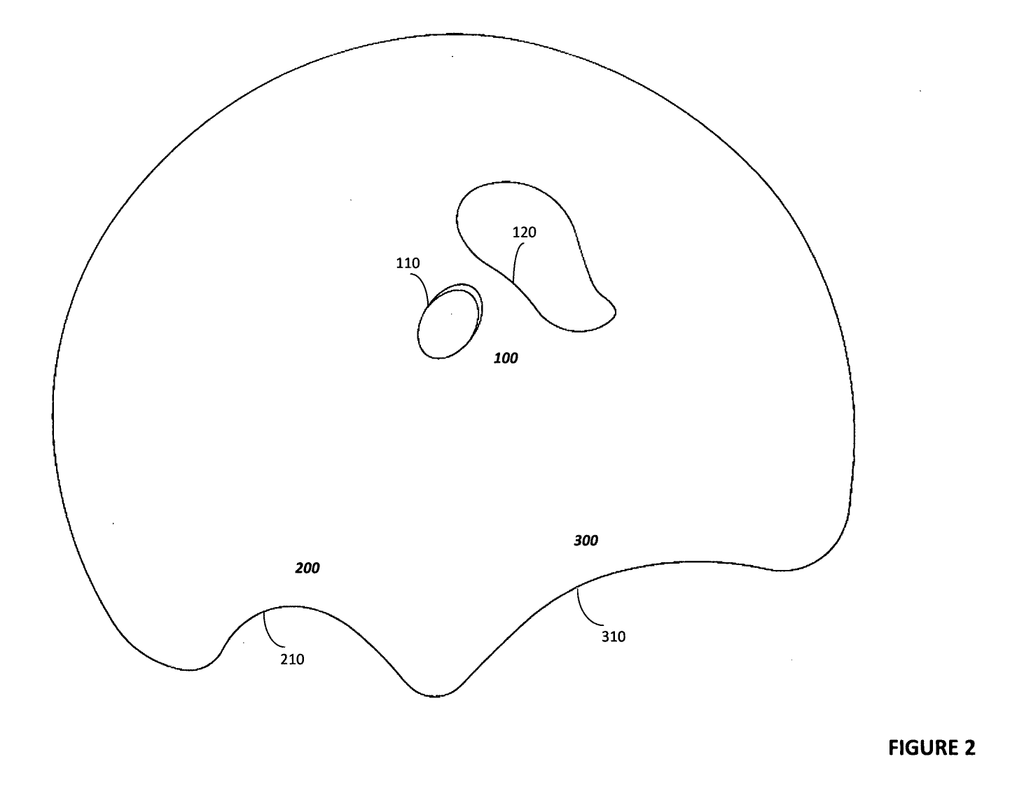

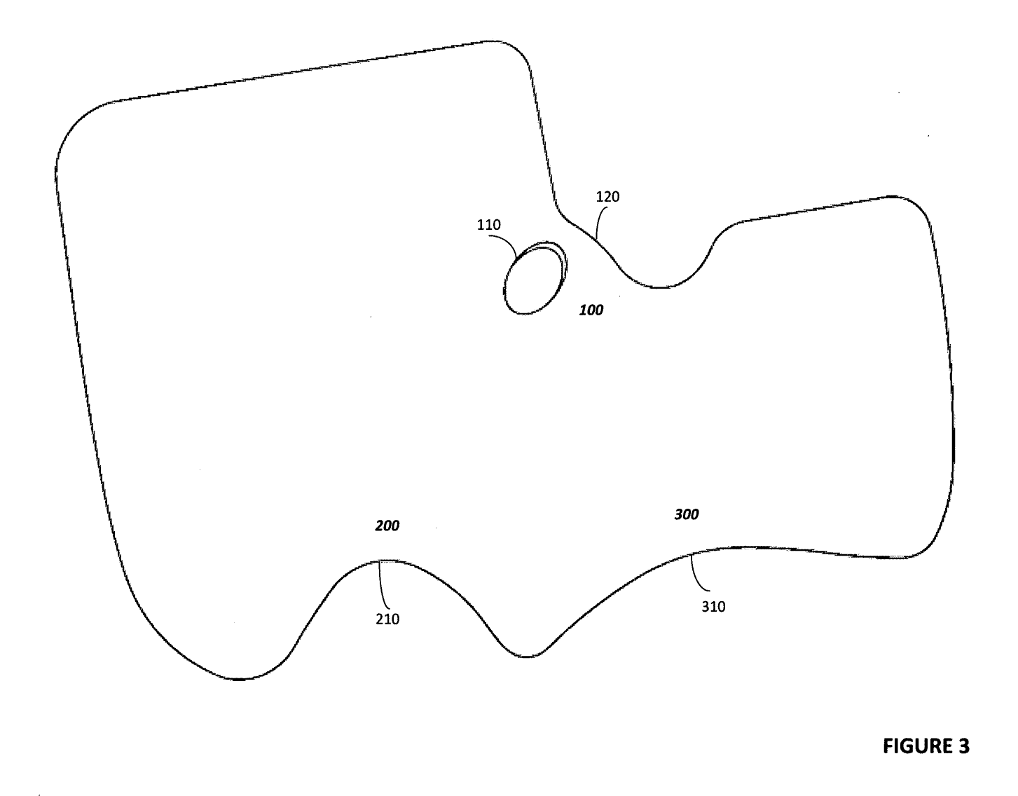

The grasping surface area 120 in each of the embodiments shown in FIGS. 1 through 7 is provided to assist in holding the palette on the forearm as part of the three-point anchor system. The grasping surface area 120 may comprise a paint bearing surface and the non-paint bearing surface. It will be appreciated the palette may be held without fingers wrapping around the paint bearing surface. In FIGS. 1 through 7, the shape of the grasping surface 120 is adjacent to the thumb resting surface 110 in proportion to the size of artist's palm and digits fanning away from the thumb. In FIGS. 1 and 2, the grasping area 120 is located inside the surface area of the palette plane. In FIGS. 3 through 7, the grasping area 120 forms part of the outer circumference of the palette.

The forearm resting surface 210 in each of the embodiments shown in FIGS. 1 through 7 is provided to assist in holding the palette on the forearm. In one embodiment, the forearm resting surface 210 includes a concave arc curving toward the first anchor point 100. This feature makes the second anchor point 200 more stable and ergonomic, enabling a better fit with the contour of the artist's arm and more specifically a bicep. By way of illustration, curving away from the first anchor point 100 would produce an undesired effect, both causing discomfort to the artist and poor anchoring function.

The torso resting surface 310 in each of the embodiments shown in FIGS. 1 through 7 is provided to assist in holding the palette on the artist's torso or a hip. In one preferred embodiment, the torso resting surface 310 includes a concave arc curving toward the first anchor point 100. This feature makes the third anchor point 300 more stable and ergonomic, enabling a better fit with the contour of the artist's torso and more specifically stomach and oblique areas. By way of illustration, curving away from the first anchor point 100 would produce an undesired effect, both causing discomfort to the artist and poor anchoring function.

In a preferred embodiment, the three-point anchor system forms a triangle from the first anchor point 100, the second anchor point 200 and the third anchor point 300, within the geometric plane of the novel palette. The formed triangle enables improved stability, ergonomics and more effective weight distribution.

FIG. 2 illustrates a design similar to FIG. 1 in the described features and further demonstrates that the first anchor point 100 may be moved around from being relatively centrally located closer to the edge of the palette. This could be done to control for various palette sizes desired by artists for different kinds of tasks or even on more custom fit basis to accommodate for different lengths of arms.

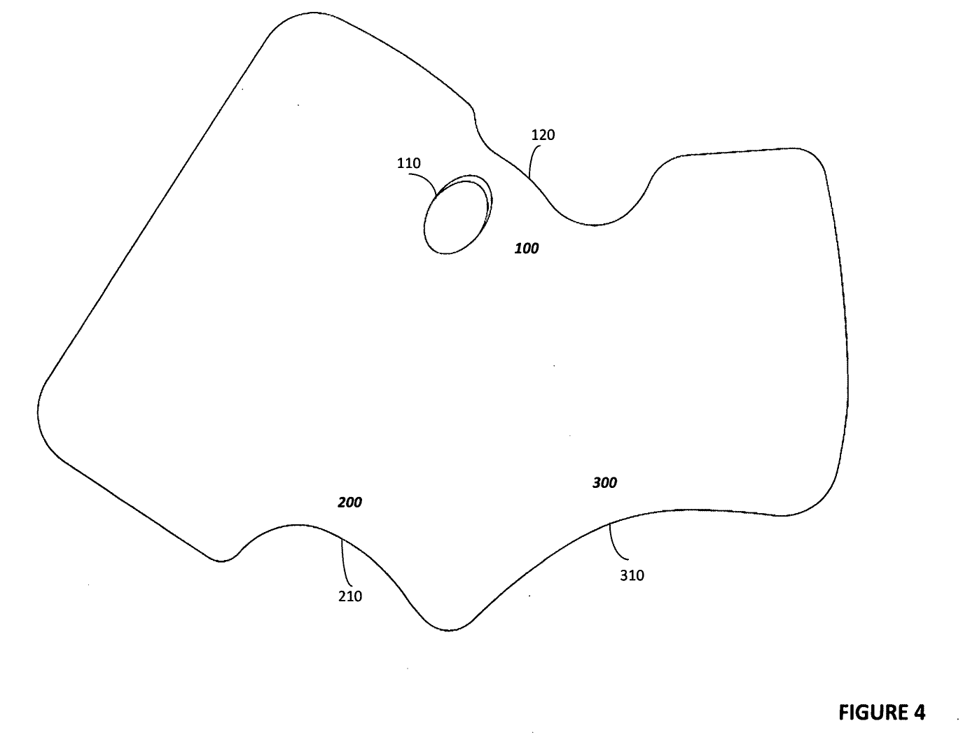

FIG. 3 illustrates a design similar to FIG. 1 in the described features the third anchor point 300 further includes a hip resting surface. With this embodiment, the artist may use the palette to anchor the palette onto the hip, further distributing the weight to lower core extremities for comfort and ease of use. FIGS. 4 through 7 further illustrate embodiments of the present invention.

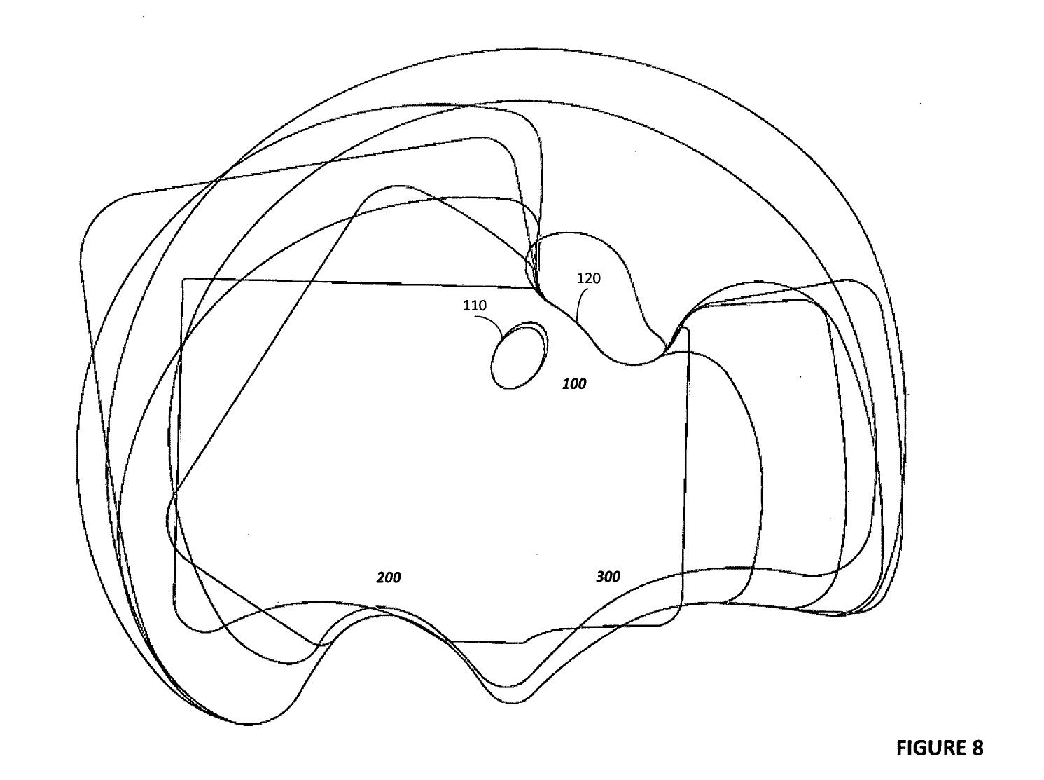

FIG. 8 illustrates FIG. 1-7 superimposed onto one another featuring the triangle formed between the first 100, the second 200 and the 300 third anchor points. In one embodiment, the triangle ABC is formed whereby point A corresponds to a first point atop the thumb resting surface 110, point B corresponds to a second point on the torso resting surface 310, forming the shortest distance between the points A and B, and point C corresponds to a third point on the forearm resting surface 210, forming the shortest distance between the points A and C. In one embodiment, the triangle ABC comprises an acute angle ABC. In another embodiment, the triangle ABC comprises an angle ABC of less than one hundred degrees.

The improved painting experience will result from providing an artist with the palette including a triangle formed by the first 100, the second 200 and the third 300 anchor points, coplanar with the palette. Artist would insert a thumb through the thumb resting surface 110 of the first anchor point 100. Artist would also grasp the grasping surface area 120 of the first anchor point 100 with fingers facing away from the thumb resting surface 110. The grasping surface area 120 may comprise a paint bearing surface and the non-paint bearing surface. It will be appreciated, the artist may hold the palette without fingers wrapping around the paint bearing surface. Artist would also rest a non-paint-bearing surface of the palette and the second anchor point 200 on a forearm using a forearm resting surface 210, forming a line between the first 100 and the second anchor points 200. Artist would also rest the torso resting surface 310 of the third anchor point 300 on a torso, forming the triangle between the first 100, the second 200 and the third 300 anchor points, coplanar with the palette.

It will be appreciated that disclosed novel artist palette may be made comprising substrate composed of either one of or combination of, including but not limited to, wood, plastic, acrylic, paper or composite materials. The palette may further be used by artists to mix and hold paint colors while painting with oil or acrylic paints or with any of the variety of inks, including, but not limited to, any mixed oil and dry pigment, further including pigments utilizing oil resins needed to bind by grinding, with adding percentages of fillers in paint, and usable consistency by volume of character of pigment-in varied oil absorption from its mineral.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

1. An artist palette comprising
a first anchor point including a thumb resting surface and a grasping surface;
a second anchor point including a forearm resting surface forming a line with the first anchor point parallel to the forearm; and
a third anchor point including a torso resting surface forming a triangle together with the first anchor point and the second anchor point.

2. The artist palette according to claim 1 wherein the grasping surface is located internally to the area of the palette circumference.

3. The artist palette according to claim 1 wherein the grasping surface forms a part of the palette circumference.

4. The artist palette according to claim 1 wherein the third anchor point further includes a hip resting surface.

5. The artist palette according to claim 1 wherein the palette substrate comprises at least one of or a combination of wood, plastic, acrylic, paper or composite materials.

6. The artist palette according to claim 1 wherein the forearm resting surface includes a concave arc curving toward the first anchor point.

7. The artist palette according to claim 1 wherein the torso resting surface includes a concave arc curving toward the first anchor point.

8. A method of providing an improved painting experience comprising providing an artist palette including a triangle formed by a first, a second and a third anchor point, coplanar with the palette;
inserting a thumb through a thumb resting surface of the first anchor point;
grasping a grasping surface of the first anchor point with fingers facing away from the thumb resting surface;
resting a non-paint-bearing surface of the palette and the second anchor point on a forearm using a forearm resting surface and forming a line between the first and the second anchor points; and
resting a torso resting surface of the third anchor point on a torso and forming the triangle between the first, the second and the third anchor points, coplanar with the palette.
